(19) United States
(12) Patent Application Publication
(10) Pub. No.: US 2015/0033905 A1
(43) Pub. Date: Feb. 5, 2015

(54) Control pedal, in particular for a motor vehicle

(71) Applicant: ZF Friedrichshafen AG, Friedrichshafen (DE)

(72) Inventors: Andreas HOFFMANN, Steinfeld (DE); Keit Wagener, Bissendorf (DE); Thorsten Kamphaus, Lohne (DE); Burkhard TIEMANN, Bad Essen (DE)

(73) Assignee: ZF Friedrichshafen AG, Friedrichshafen (DE)

(21) Appl. No.: 14/287,436

(22) Filed: May 27, 2014

(30) Foreign Application Priority Data
Aug. 1, 2013 (DE) 102013215067.9

(51) Int. Cl. G05G 1/44

(52) U.S. Cl. CPC G05G 1/44
USPC 74/560

(57) ABSTRACT

The invention relates to a control pedal (1), in particular for a motor vehicle. The control pedal (1) is characterized by a pedal arm (3) which has in the lengthwise direction (5) at least one organo-sheet reinforcement part (7) with a cross-sectional area (17) that is open perpendicular to the lengthwise direction (5) of the pedal arm (3). The open cross-sectional area (17) of the at least one organo-sheet reinforcement part (7) is at least in sections dosed by a cover part (9) for increasing the bending stiffness and the torsional stiffness.

### BACKGROUND OF THE INVENTION

1. Field of the Invention

The invention relates to a control pedal, in particular for motor vehicles, having a pedal arm, having in its lengthwise direction at least one organo-sheet reinforcement part with a cross-sectional area (17) that is open perpendicular to the lengthwise direction of the pedal arm.

2. Description of Related Art

Control pedals for motor vehicles, i.e. passenger vehicles and commercial vehicles, are known in many embodiments. To satisfy the requirement for a smallest possible component weight or a smallest possible component mass, control pedals in lightweight construction using so-called organo-sheets were developed. Organo-sheets within the context of the present invention refer to a fiber composite material (FCM) in form of a continuous-fiber-reinforced thermoplastic material. Reinforcement fibers embodied as glass fibers, carbon fibers or aramide fibers and/or Kevlar, in particular in the form of continuous fibers are used for absorbing the load. To ensure the orientation and dimensional stability of the fiber, the aforementioned reinforcement fibers are embedded in a thermoplastic matrix material (e.g. polyamide, PA). The fibers embedded in the matrix material can hereby be oriented in form of a fabric or a mat in a single direction or at any mutual angle.

DE 10 2011 003 222 A1 describes a control pedal with a pedal arm, wherein the pedal arm has in the longitudinal direction an organo-sheet reinforcement part with a cross-sectional area that is open perpendicular to the lengthwise direction of the pedal arm.

Control pedals must also satisfy high demands regarding bending stiffness and torsional stiffness, which must be reconciled with the requirement for the smallest possible component mass. For example, in an emergency stop or during full braking, extremely high forces can be applied by the vehicle operator on a control pedal embodied as a brake pedal. A high torsional stiffness is also desirable and required for a control pedal in order to give the vehicle operator a direct and secure sensation when he depresses the control pedal, e.g. by preventing him from laterally slipping off the control pedal. The bending stiffness is also required when an actuating force is applied at an angle, i.e. when the actuating force is not perpendicular to a bearing axle of a pivot bearing of the control pedal. This may be the case, for example, when the control pedal is constructed as a control pedal for a parking brake and is arranged in a foot compartment of the motor vehicle on the side in the direction of an outer side of the vehicle.

Control pedals are frequently not straight in the direction of their length, but have an offset. A kick plate of the control pedal can be relatively wide, in particular when this applies to the kick plate of a brake pedal of a motor vehicle with an automatic transmission. When the actuating force of a relatively strongly offset control pedal with a relatively wide kick plate is applied at the position of the kick plate which has the greatest distance from the pivot bearing of the control pedal, then depending on the strength of the actuating force, a relatively high torsional moment can be superimposed on a bending moment, which must, inter alia, be absorbed by the pedal arm.

### BRIEF SUMMARY OF THE INVENTION

It is an object of the invention to provide a lightweight control pedal with a relatively small component volume, which has high bending stiffness and high torsional stiffness.

This object is attained according to the present invention by a control pedal of the aforedescribed type, which has in addition the characterizing features of claim 1.

Preferred embodiments and improvements are recited in the dependent claims.

The invention therefore provides a control pedal, in particular a control pedal for a motor vehicle, with a pedal arm that has in the lengthwise direction at least one organo-sheet reinforcement part with a cross-sectional area that is open perpendicular to the length of the pedal arm. The invention proposes that the open cross-sectional area of the at least one organo-sheet reinforcement part is closed of at least in sections by at least one cover part for increasing the bending stiffness and the torsional stiffness of the pedal arm.

Control pedals in the context of the present invention are clutch pedals, pedals for parking brakes, brake pedals and gas pedals, which allow a conventional mechanical or an electronic (pedal by wire) actuation of the associated units. Longitudinal extent or lengthwise direction of the pedal arm refers to the connection segment of the control pedal which connects a kick plate of the control pedal with a pivot bearing of the control pedal for pivotable support of the control pedal. This connection segment may be constructed to be either straight or not straight in a single plane or in several planes, for example bent, angled or offset.

In addition to an embodiment with a single organo-sheet reinforcement part, embodiments with more than one organo-sheet reinforcement part can also be envisioned. The cross-sectional area that is open perpendicular to the length of the pedal arm refers to, for example, the open longitudinal side of an organo-sheet reinforcement part with a U-shaped, semicircular or angled cross-sectional area. The cross-sectional area can be constructed identical or different over the length of the pedal arm.

The open cross-sectional area of the organo-sheet reinforcement part can be closed off completely or partially by the cover part. In addition, several cover parts distributed over the length of the pedal arm may also be provided. In this way, sections of the pedal arm where particularly high bending and/or torsional stresses occur when high actuating forces are applied can be specifically reinforced.

The control pedal can be used in motor vehicles in general, for example passenger cars, commercial vehicles, motor vehicle having any type of propulsion, for example an internal combustion engine or an electric motor, as well as motorized road and rail vehicles or all-terrain vehicles, including track vehicles.

Closing the open cross-sectional area with the cover part produces a dimensional stable, closed hollow profile, which is particularly adapted to absorb even high bending and torsional moments. With the closed construction being a hollow profile, high moments of resistance against bending and torsion are achieved in spite of the relatively small component volume. No material is present inside the hollow profile, because this would contribute very little to the absorption of the bending and/or torsional moments due to the relatively small distance from the bending or torsion axis. A bending and torsion resistant control pedal in lightweight construction can thereby be realized.

Advantageously, the cover part has a substantially constant material thickness. A cover part with a constant material thickness can be produced particularly cost-effectively from a semi-finished starting product. A thin wall sheet-like material or a continuous material wound on a spool can be used as semi-finished product, from which cover parts are cut out or separated with, for example, water jet technology. In addition, a massive solid rod may also be used as semi-finished product, from which the cover parts are cut of, for example sawed of, in form of disks.

According to another embodiment, the cover part is formed from an organo-sheet. By using organo-sheet for the cover part, the organo-sheet reinforcement part and the cover part closing of the open cross-sectional area of the reinforcement part are formed from the same material. Because the material properties of the two adjacent parts are identical or at least similar, the resulting bending and/or torsional stresses are particularly advantageously distributed when an actuating force is applied to the control pedal. The two adjacent parts have each a thermoplastic matrix material which enables—after prior heating—a material connection of both parts without a (welding) additive. For example, for producing a material connection, a previously heated joining region or several joining regions of the organo-sheet reinforcement part may be immersed in one or several likewise previously heated joining regions of the cover part made from organo-sheet. The joining region(s) of the cover part are advantageously located in the surface of the cover part facing the open cross-sectional area of the organo-sheet reinforcement part. It is hereby advantageous to select for the cover part and organo sheet material that has a sufficiently thick layer made of a thermoplastic matrix material and disposed between its surface facing the open cross-sectional area of the organo-sheet reinforcement part and a fabric layer made of continuous fibers and embedded in the organo-sheet material. The weight or the mass of the cover part can be kept small by orienting the continuous fibers arranged in the organo-sheet commensurate with the stress of the control pedal.

According to an advantageous embodiment, a cross-sectional area, in particular an arbitrary cross-sectional area, of the cover part has a contour different from a flat shape. A contour of the cross-sectional area different from a flat shape refers in this context to a cross-sectional area of the cover part that is different from a rectangular shape. A relatively lightweight cover part can thus be provided by using a cover part with a contour which is designed for a uniform distribution of the bending and/or torsional stresses that occur when a load is applied on the control pedal. The contour of the cover part may here be oriented in the direction and/or perpendicular to the length of the pedal arm, The contour may be uniform or nonuniform in the two aforementioned directions. When the contour is formed to be nonuniform in the lengthwise direction of the pedal arm, the contour is advantageously continuous in order to prevent stress peaks.

Advantageously, the contour of the cover part is delimited by at least two substantially parallel surfaces of the cover part. These surfaces are here the surface of the cover part that simultaneously forms an outer surface of the pedal arm and the surface of the cover part oriented parallel to this surface. An arrangement with exactly two mutually parallel surfaces is attained when the cover part has a cross-sectional area in the form of an annular segment. Cover parts with a contour that is delimited by essentially at least two substantially mutually parallel surfaces of the cover part advantageously provide relatively large proportions on the resistance moments with respect to bending and/or torsion, depending on the position of the bending or the torsion axis of the control pedal.

According to another advantageous embodiment of the invention, the contour of the cover part is oriented substantially parallel and/or perpendicular to a pivot axis of the control pedal. This arrangement has a particularly high moment of resistance against bending, in particular when the bending axis of the control pedal extends parallel to its pivot axis. Portions of the cross-sectional area of the cover part that are located relatively close to a bending axis and contribute only little to the moment of resistance against bending are minimized.

Advantageously, the cover part has a U-shape with legs pointing in the direction of the open cross-sectional area of the organo-sheet reinforcement part. This arrangement is particularly advantageous when the base side of the U-shaped cover part that is delimited by the two legs is oriented perpendicular to the bending axis. The control pedal experiences a bending stress when an actuating force is applied via the kick plate. This bending stress produces a shear stress in the region of the bending axis. With an arrangement of the base side of the U-shaped cover part that is delimited by the two legs perpendicular to the bending axis, the produced shear stresses are safely absorbed, because the base side of the cover part is at this location over its entire area available for receiving the shear stresses. The open side of the U-shaped cover part can be oriented, depending on the current load condition and the geometry of the control pedal, laterally, i.e. in the direction of the pivot axis, or perpendicular to the pivot axis.

Advantageously, the cover part may be formed of a plastic material, in particular of an injection-moldable plastic material with fiber reinforcement. Cover parts with a contour in one or several directions may advantageously be produced by a plastic injection molding process. Injection-moldable thermoplastic materials can hereby be used as materials. The thermoplastic materials may be provided with a fiber reinforcement, for example from glass fibers or carbon fibers, to increase their strength. A suitable material is for example PA6GF50.

According to an advantageous embodiment, the cover part has at least one geometric region with an integral function. A geometric region with an integral function in this context refers to a functional element and/or a receptacle for a functional element and/or a connection for a functional element. Functional elements may be, for example, stop surfaces or control surfaces, for example for a brake light switch controlled by a spring-loaded pin contact. A receptacle for a functional element may be, inter alia, a slot for receiving a metal plate that forms a sensor surface for a brake light switch. Connection for functional elements may, for example, refer to a connection for a support which connects an end region of a connecting rod for a brake booster to a control pedal embodied as a brake pedal, or a connection for part of a pedal force simulation device of a control pedal embodied as pedal-by-wire. The connection can be constructed, for example, as a bayonet lock.

The geometric regions with integral functions may be connected to the cover part by overmolding using a plastic injection molding process. When the cover part is produced with an injection molding process, the geometric regions with the integral function may advantageous be injection-molded in a single process step. The geometric regions with integral functions may alternatively also be connected to the cover part using other methods that provide positive, non-positive or material connections.
Connecting geometric regions with integral functions to the cover part advantageously makes use of otherwise unused surfaces of the cover part. In addition, production of the cover part can be decoupled from the production of the rest of the control pedal.

Advantageously, a bonding layer formed of a thermoplastic material is arranged between at least one contact surface of the organo-sheet reinforcement part and a corresponding contact surface of the cover part. By forming the bonding layer of a thermoplastic material, and depending on the geometric construction of organo-sheet reinforcement part and cover part, the contact surface of the of general metal reinforcement part and/or the corresponding contact surface of the cover part are sealed. In this way, any reinforcement fibers of the organo-sheet material protruding from the interfaces or intersecting faces of the organo-sheet reinforcement part and/or of the cover part are over-melted or covered with the thermoplastic material of the bonding layer.

Advantageously, the bonding layer is associated with the organo-sheet reinforcement part. By applying the bonding layer on the organo-sheet reinforcement part, the open cross-sectional area of the organo-sheet reinforcement part is stabilized. The organo-sheet reinforcement part with the bonding layer applied thereto preferably by injection molding provides a geometrically defined joining region for subsequent joining with the cover part. When the bonding layer associated with the organo-sheet reinforcement part is produced using an injection molding process, the kick plate and the pivot bearing of the control pedal as well as optionally other geometric regions providing integral functionality can also be overmolded on the organo-sheet reinforcement part in a single process step.

Advantageously, the contact surfaces between the organo-sheet reinforcement part and the cover part or between the bonding layer and the organo-sheet reinforcement part or between the bonding layer and the cover part are constructed to be flat at least in one direction, while allowing a degree of freedom in this direction of at least±1 mm. In this way, the organo-sheet reinforcement part and the cover part can be connected by vibration welding.

Advantageously, the organo-sheet reinforcement part and the cover part are connected with one another materially, in particular by vibration welding, hot plate welding, ultrasound welding or gluing. With a material connection, the organic metal reinforcement part and the cover part are connected with one another without play. The aforementioned welding methods can be used, in particular, when the partners to be joined are either completely formed of a thermoplastic material or have at least a thermoplastic matrix material. When the cover part is not made of a thermoplastic material or of an organo-sheet, an adhesive method can be used for producing a material connection between the organo-sheet reinforcement part and the cover part, for example using a two-component adhesive. High reproducibility with respect to strength, for example shear strength, can be attained with the aforementioned material joining methods.

It is desirable when operating control pedals that a defined failure of the control pedal occurs from a certain actuating force on which substantially exceeds the actuating force for normal operation and which therefore can also be referred to as misuse force. At least a limited actuation of the control pedal should still be possible in this serious situation. In addition, failure of the control pedal should be indicated to the operator of the motor vehicle, for example by noticeable damage to the control pedal.
Due to the high reproducibility in the production of the material connection, the desired defined failure of the control pedal from a certain misuse force on can be achieved by the material connection itself. When the misuse force is reached, the material connection starts to detach by way of a peeling process that continuous with further increase in the actuating force. The misuse force can therefore be somewhat adjusted by designing the material connection.

Alternatively, the organo-sheet reinforcement part and the cover part may be positively or non-positively connected with one another, in particular by way of a clip connection, a screw connection or a rivet connection.

A positive connection is produced, for example, by forming the organo-sheet reinforcement part with a U-shaped cross-sectional area and the cover part with a mating hat profile that engages in the open cross-sectional side of the organo-sheet reinforcement part.

A clip connection, also referred to as snap-in connection, for connecting the aforementioned joining partners is particularly easy to install. The organo-sheet reinforcement part and the cover part may also be connected with one another by a combination of material, positive and non-positive joining methods.

Advantageously, a cavity enclosed by the organo-sheet reinforcement part and the cover part is filled at least partially by a ribbed structure having webs, wherein the webs are delimited in their lengthwise direction by interior walls of organo-sheet reinforcement part and cover part. Advantageously, the webs are at their boundary with the cover part materially connected to the cover part so as to allow in this region a force flow between the webs of the ribbed structure and the cover part or vice versa. By employing the ribbed structure arranged between the interior walls of organo-sheet reinforcement part and cover part, the control pedal, in particular the pedal arm of the control pedal, attains a high stiffness. The ribbed structure is preferably associated with the organo-sheet reinforcement part and formed of injection moldable thermoplastic material. In this way, the organo-sheet reinforcement part can be inserted into an injection molding tool and the ribbed structure, the kick plate, the pivot bearing, the bonding layer and optionally additional geometric regions providing integral functionality can be produced with an injection molding process in a single operation by subsequent molding and/or overmolding. The ribbed structure is hereby completely produced and protrudes, when the cover part has for example a U-shape, from the open cross-sectional area of the organo-sheet reinforcement part. This arrangement represents a positioning aid when the organo-sheet reinforcement part is subsequently joined with the cover part.

Instead of the ribbed structure for stiffening the pedal arm, the cavity enclosed by the organo-sheet reinforcement part and the cover part may also be filled with a suitable form material, preferably on a two-component basis.

Advantageously, the longitudinal direction of the webs extends substantially parallel or perpendicular to the pivot axis of the control pedal. The longitudinal direction of the webs depends on the orientation of the open cross-sectional area of the organo-sheet reinforcement part. In addition, demolding after the injection molding process for producing the webs must be ensured. When the open cross-sectional area of a control pedal constructed as a brake panel with a U-shaped organo-sheet reinforcement part is oriented in the direction of the brake booster when installed in the motor vehicle, then the longitudinal direction of the webs advantageously extends perpendicular to the pivot axis of the brake pedal, as illustrated in DE 10 2011 003 222 A1. In this case, the support connecting the end region of the connecting rod to the brake booster with the brake pedal can be arranged inside the pedal body and protected from damage. For this purpose, the cover part is provided with an opening through which the connecting rod passes. Should it not be possible to interrupt the ribbed structure for the receptacle of the aforementioned support due to concerns about the stiffness, then a connection for the support may also be provided on the outside of the cover part opposite the ribbed structure.

### BRIEF DESCRIPTION OF THE SEVERAL VIEWS OF THE DRAWING(S)

The invention will now be described in more detail with reference to the drawings which illustrate only exemplary embodiments. The drawings show in:

FIG. 1 a perspective diagram of a first embodiment of a control pedal after assembly;

FIG. 2 an exploded view of the control pedal according to the embodiment according to FIG. 1;

FIG. 3 a cross-sectional view of the control pedal according to the first embodiment taken along the line 1-1 in FIG. 1;

FIG. 4 a perspective view of the control pedal according to a second embodiment before assembly;

FIG. 5 a perspective view of the control pedal according to a third embodiment;

FIG. 6 a perspective view of the control pedal according to another embodiment, and

FIG. 7 a detail A of FIG. 6 on an enlarged scale.

### DETAILED DESCRIPTION OF THE INVENTION

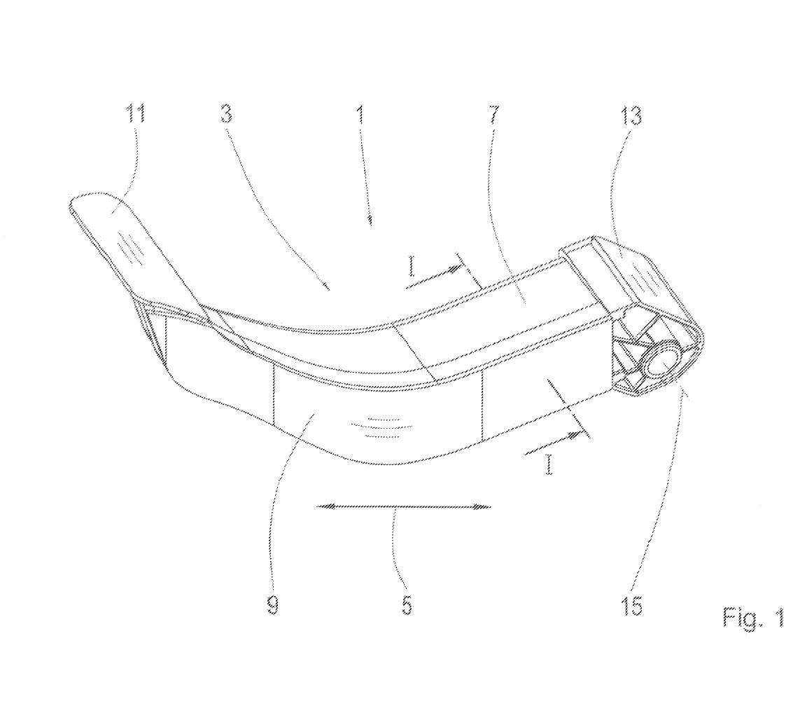

FIG. 1 shows a control pedal 1 with a pedal arm 3, which has along its length 5 an organo-sheet reinforcement part 7 and a cover part 9. The pedal arm 3 connects a kick plate 11 with a pivot bearing 13 which when installed in a motor vehicle enables a rotation about a pivot axis 15 of the control pedal 1.

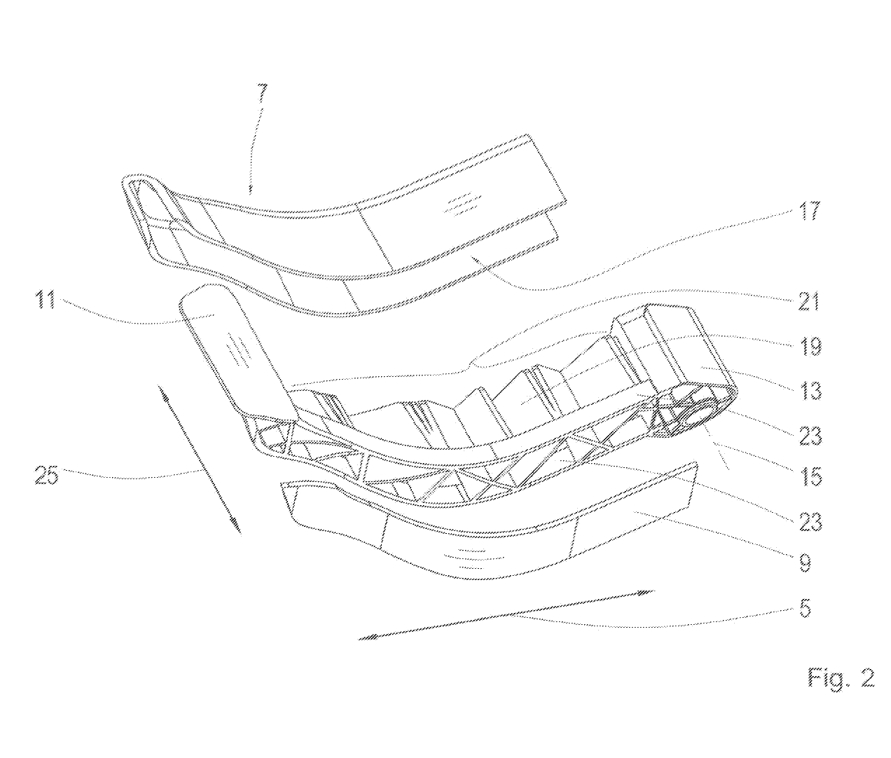

The organo-sheet reinforcement part 7 which is shown separately in FIG. 2 has a U-shaped cross-section and is produced from a plate-shaped organo-sheet semi-finished product by thermal forming and subsequent cutting by water jet cutting technology. The organo-sheet reinforcement part 7 has an open cross-sectional area 17 extending in the lengthwise direction 5 of the pedal arm 3. A one-piece compound structure of a thermoplastic material is produced in or on this open cross-sectional area 17 by injection molding which includes the kick plate 11, the pivot bearing 13, a ribbed structure 21 formed of webs and two bonding layers 23. The webs 19 extend in a direction 25 that runs parallel to the pivot axis 15 of the control pedal. The lengthwise direction 25 of the webs 19 corresponds to a demolding direction for producing the aforedescribed compound structure by injection molding. This compound structure forms in conjunction with the organo-sheet reinforcement part 7 a subassembly which is subsequently closed off by the cover part by way of vibration welding.

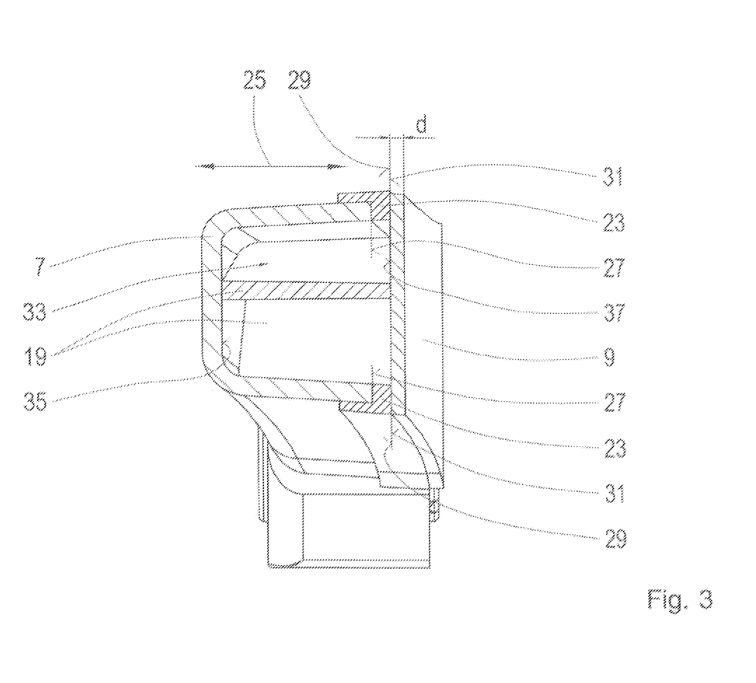

The organo-sheet reinforcement part 7 with the webs 19 arranged thereon as well as their lengthwise direction 25 can be seen in FIG. 3. The narrow surfaces of the two free ends of the U-shaped organo-sheet reinforcement part 7 facing the cover part 9 represent contact surfaces 27. The cover part 9 has opposing contact surfaces 29. A corresponding bonding layer 23 which in this case seals the contact surfaces 29 of the organo-sheet reinforcement part 7 is arranged between the contact surfaces 29 of the organo-sheet reinforcement part 7 and the contact surfaces 29 of the cover part. At the same time, the free ends of the organo-sheet reinforcement part having a U-shaped cross-section are additionally stabilized in that the bonding layer 23 having an L-shaped cross-section extends with one leg on the outer circumference of the organo-sheet reinforcement part 7. The contact surfaces 29 of the cover part 9 make contact with the bonding layer 23 at the contact surfaces 31 which are associated with the bonding layer.

A cavity 33 is enclosed by the organo-sheet reinforcement part 7, the bonding layer 23 and the cover part 9. The webs 19 extend in this cavity 33 from an interior wall 35 of the organo-sheet reinforcement part 7 to an interior wall of the cover part. Each of the webs 19 is materially connected with both interior walls 33, 35. The cover part 9 is formed of an organo-sheet with a constant material thickness d. The material of the organo-sheet reinforcement part 7 and the material of the cover part 9 each have the same matrix material. Alternatively, both parts could also be directly materially connected with each other by a thermal joining method, without the interposed bonding layers 23.

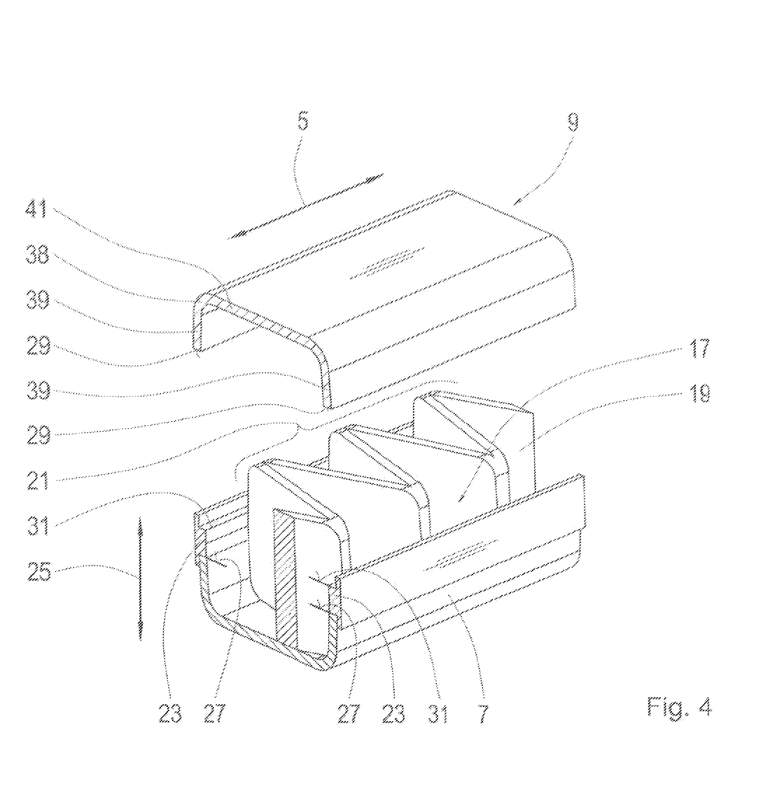

FIG. 4 shows a section of the pedal arm 3 after overmolding of the ribbed structure 21 and the two bonding layers 23 on the organo-sheet reinforcement part 7. The webs of the ribbed structure have in turn a lengthwise direction 25 which corresponds to the demolding direction after injection molding. The bonding layers 23 have in this exemplary embodiment a hat-shaped cross-section, and the ribbed structure 21 projects out of the open cross-sectional area 17 of the organo-sheet reinforcement part 7.

The cover part 9 has in this case, like the organo-sheet reinforcement part 7, also a U-shaped cross-sectional area 38 with two legs 39 and a base side 41 enclosed by the legs 39. The cover part 9 is also produced by forming when warm and subsequent cutting by way of water jet technology. After the U-shaped cover part 9 is placed on the organo-sheet reinforcement part 7 with the overmolded ribbed structure 21 and the overmolded bonding layers 23, the portion of the rib structure 21 protruding from the open cross-sectional area 17 of the organo-sheet reinforcement part 7 is enclosed by the legs 39 and the base side 41 of the cover part 9.
The cover part 9 which in this exemplary embodiment only closes off a partial section of the pedal arm is connected with the ribbed structure 21 and the two bonding layers 23 by way of vibration welding, wherein the required process-induced oscillation of the cover part 9 occurs with amplitudes in the lengthwise direction 5 of the pedal arm 3. The actual welding takes place between the contact surfaces 29 of the cover part 9 and the corresponding contact surfaces 31 of the bonding layer 23, as well as between the common contact surfaces of the webs 19 and the cover part 9.

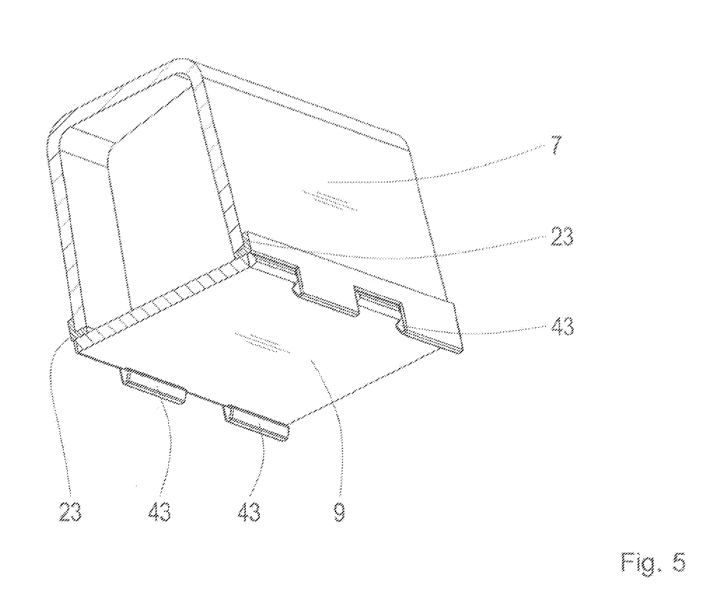

FIG. 5 shows a positive snap-in connection between the organo-sheet reinforcement part 7 and the cover part 9. Locking tabs 43 which are connected in one piece with the bonding layer 23 encompass the cover part 9 and press the cover part 9 against the bonding layer 23. The forces that occur when a load is applied to the control pedal 1 are transferred by notches in the cover part which the locking tabs encompass with a tight fit.

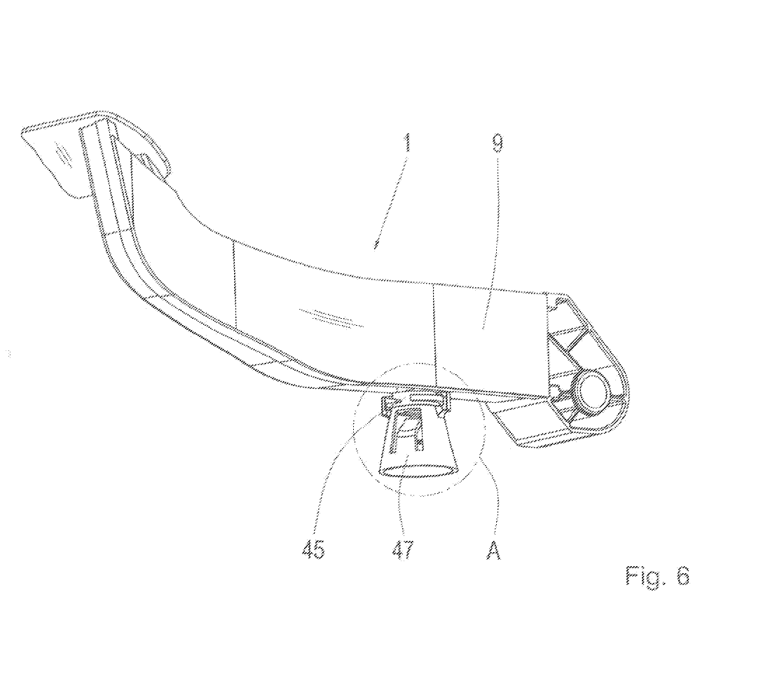

FIG. 6 shows a control pedal 1 having a geometric region 45 with integral functionality overmolded on its bottom side for connecting a support 47 which connects an end region of a connecting rod for a brake booster to the control pedal which in this exemplary embodiment is constructed as a brake pedal. When the cover part 9 is arranged on the bottom side of the control pedal 1, the aforedescribed geometric region 45 with integral functionality could also be disposed on the cover part 9, for example by injection molding.

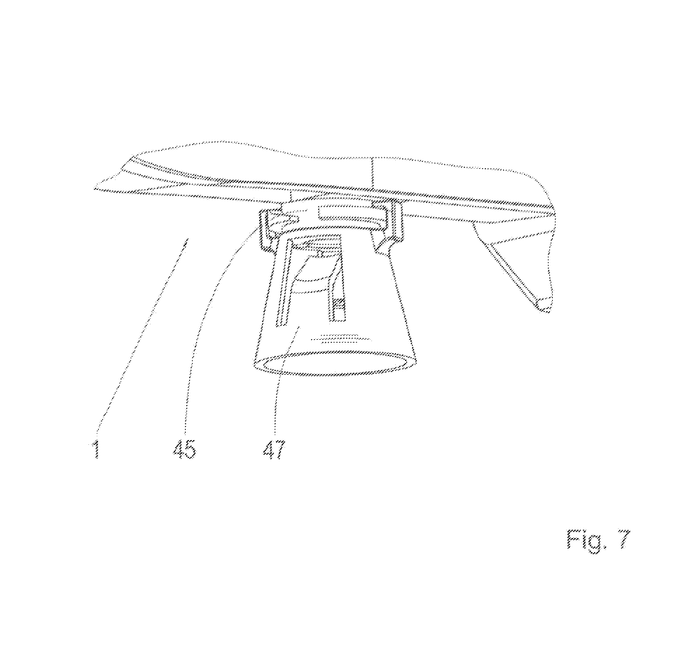

As shown in FIG. 7, the geometric region 45 with integral functionality overmolded on the control pedal 1 is constructed as part of a bayonet lock. The aforedescribed support 47 has a complementary part of the bayonet lock.

### LIST OF REFERENCE SYMBOLS

1 Control pedal
3 Pedal arm
5 Lengthwise direction of the pedal arm
7 Organo-sheet reinforcement part
9 Cover part
11 Kick plate
13 Pivot bearing
15 Pivot axis
17 Open cross-sectional area
19 Web
21 Ribbed structure
23 Bonding layer
25 Main direction of the webs
27 Contact surface of the organo-sheet reinforcement part
29 Contact surface of the cover part
31 Contact surface of the bonding layer
33 Cavity
35 Interior wall of the organo-sheet reinforcement part
37 Interior wall of the cover part
38 Cross-sectional area of the cover part
39 Leg of the cover part
41 Base side of the cover part
43 Locking tab
45 Geometric region with integral functionality
47 Support
d Material thickness of the cover part

1. A control pedal (1) for a motor vehicle, comprising
a pedal arm (3), extending in a lengthwise direction (5), including at least one organo-sheet reinforcement part (7) with a cross-sectional area (17) that is open perpendicular to the lengthwise direction (5) of the pedal arm (3),
the open cross-sectional area (17) of the at least one organo-sheet reinforcement part (7) is at least in sections closed off by a cover part (9) for increasing the bending stiffness and the torsional stiffness of the pedal arm.

2. The control pedal (1) according to claim 1, wherein the cover part (9) has a substantially constant material thickness (d).

3. The control pedal (1) according to claim 1, wherein the cover part (9) is formed of an organo-sheet.

4. The control pedal (1) according to claim 1, wherein a cross-sectional area (38), of the cover part (9) has a contour different from a flat shape.

5. The control pedal (1) according to claim 4, wherein the contour of the cover part (9) is delimited by at least two mutually parallel surfaces of the cover part.

6. The control pedal (1) according to claim 4, wherein the contour of the cover part (9) extends substantially parallel and/or perpendicular to a pivot axis (15) of the control pedal (1).

7. The control pedal (1) according to claim 1, wherein the cover part (9) is shaped with legs (39) oriented in the direction of the open cross-sectional area (17) of the organo-sheet reinforcement part (7).

8. The control pedal (1) according to claim 1, wherein the cover part (9) is formed of a plastic material.

9. The control pedal (1) according to claim 1, wherein the cover part (9) comprises at least one geometric region (45) with integral functionality.

10. The control pedal (1) according to claim 1, wherein a bonding layer (23) formed of a thermoplastic material is disposed between at least one contact surface (27) of the organo-sheet reinforcement part (7) and a corresponding contact surface (29) of the cover part (9).

11. The control pedal according to claim 10, wherein the bonding layer (23) is associated with the organo-sheet reinforcement part (7).

12. The control pedal (1) according to claim 1, wherein the contact surfaces (27, 29, 31) between the organo-sheet reinforcement part (7) and the cover part (9) or between the bonding layer (23) and the organo-sheet reinforcement part (7) or between the bonding layer (23) and the cover part (9) are constructed flat in at least one direction, with an additional freedom of movement in this direction of at least±1 mm.

13. The control pedal (1) according to claim 1, wherein the organo-sheet reinforcement part (7) and the cover part (9) are materially connected with one another, by vof of the following techniques:vibration welding, hot plate welding, ultrasound welding, laser welding or gluing.

14. The control pedal (1) according to one of the claims 1 to 12, characterized in that the organo-sheet reinforcement part (7) and the cover part (9) are connected with one another positively or non-positively, in particular with a snap-in connection, a screw connection or a rivet connection.

15. The control pedal (1) according to claim 1, wherein a cavity (33) enclosed by the organo-sheet reinforcement part (7) and the cover part (9) is at least partially filled by a ribbed structure (21) having webs (19), and wherein the webs (19) are delimited in their lengthwise direction (25) by interior walls (35, 37) of the organo-sheet reinforcement part (7) and the cover part (9).

16. The control pedal (1) according to claim 15, wherein the lengthwise direction (25) of the webs (19) extends substantially parallel or perpendicular to the pivot axis (15) of the control pedal (1).

17. The control pedal (1) according to claim 4, wherein a cross-sectional area (38) is an arbitrary cross-sectional area (38).

18. The control pedal (1) according to claim 1, wherein the cover part (9) is made by injection moldable plastic with a fiber reinforcement.
